(19) United States
(12) Patent Application Publication
(10) Pub. No.: US 2024/0250945 A1
(43) Pub. Date: Jul. 25, 2024

(54) SHARED RESOURCE ACCESS CONTROL

(71) Applicant: Arm Limited, Cambridge (GB)

(72) Inventor: Erik Persson, Lund (SE)

(73) Assignee: Arm Limited, Cambridge (GB)

(21) Appl. No.: 18/417,451

(22) Filed: Jan. 19, 2024

(30) Foreign Application Priority Data
Jan. 24, 2023 (GB) 2301030.9

(51) Int. Cl. H04L 9/40

(52) U.S. Cl. CPC H04L 63/10

(57) ABSTRACT

Provided is an access controller configured to control access to a shared resource by plural accessors operable to issue requests for access to the shared resource, the access controller comprising a predictor configured to analyze an activity of an accessor to determine a type of at least one event; predict a future request state of at least one of the accessors based on the determination; and select one of the plurality of accessors to be granted access to the shared resource on a future processor cycle, the selecting being computed using at least the prediction.

### BACKGROUND

The present technology is directed to the control of access to shared resources in electronic systems, such as electronic computing systems, and in particular to the reduction in wasted processor cycles caused by stalls in the handling of resource access requests and resource access grants by access controllers, and especially access controllers comprising registered arbiters.

Many electronic computing systems rely for their efficient operation on the use of shared resources, such as memory, other storage resources, communications channels, input/output devices and the like. Computer processing systems rely for the synchronisation of their activities upon a sequence of processor cycles generated, typically, by some form of electronic oscillator, and the operations of fetching and executing instructions, including requesting and receiving grants of access to resources, are thereby coordinated.

### BRIEF DESCRIPTION OF THE FIGURES

Implementations of the disclosed technology will now be described, by way of example only, with reference to the accompanying drawings, in which:

FIG. 1 shows a simplified example of an apparatus according to an implementation of the present technology and comprising hardware, firmware, software or hybrid components;

FIG. 2 shows further detail of an apparatus according to an implementation of the present technology and comprising hardware, firmware, software or hybrid components;

FIG. 3 shows a much simplified view of a method of operation of an access controller according to the implementations of the present technology;

FIG. 4 shows a tabular representation of an example of some event and prediction states in memory according to an implementation of the present technology; and

FIG. 5 shows a simplified view of an apparatus configured for sequence prediction according to an implementation of the present technology.

### DETAILED DESCRIPTION

Like any other computer process, arbitration among requesters to selectively grant and refuse resource access requests is a process operated according to these processor cycles. Typically, an arbiter operates to select an accessor to which to grant access for a particular processor cycle, often according to an order such as a round robin (RR) order, whereby each accessor of a set of accessors is granted access in sequence until each has had one turn, the sequence then beginning again at the first accessor of the set. In an alternative, a set of accessors may be granted access in turn according to a sequence beginning at the least recently-granted accessor (LRG). As will be immediately clear to one of skill in the art, the arbitration and selection process takes an appreciable amount of processor time in a processor cycle.

A registered arbiter is one in which the granting of resource access to an accessor is determined for a next processor cycle, rather than for the current processor cycle. While this registered arbiter approach reduces the burden of processing that is needed during the current processor cycle by shifting part of the processing burden forward in time to a preceding processor cycle, it is susceptible to wasted processor cycles when a predicted request is granted, but is not then used by the selected accessor that has been granted access for that processor cycle.

Both the RR and LRG methods of selecting a next accessor to be granted access suffer from the wastage caused by selection of an accessor that is not ready to use the granted access, and that may therefore prevent an accessor that is more likely to be ready to use the granted access from acquiring that access. The inventors have perceived that there may be better ways of selecting accessors to be granted access, and that it would be useful to alleviate at least some of this wastage by applying probabilistic techniques to the prediction of likely next cycle requesters.

In an approach to addressing some difficulties in the handling of resource access requests and resource access grants by access controllers, the present technology provides an access controller, an electronic crossbar structure, and a neural network accelerator as defined in the appended claims.

In other approaches, a computer-implemented method may be used for access control according to the present technology, and that method may be realised in the form of a computer program operable to cause a computer system to perform the process of the present technology. As will be clear to one of skill in the art, a hybrid approach may also be taken, in which hardware logic, firmware and/or software may be used in any combination to implement the present technology.

There is thus provided in the present technology an apparatus and method for predicting the accessor most likely to request and use a grant of access to a shared resource, thereby potentially reducing the number of wasted processor cycles when an accessor is granted access and fails to exploit that grant of access to perform a useful transaction on the shared resource. For certain types of resource (for example, striped memory resources) the number of wasted cycles of a system not using the present technology (that is, one relying on a normal round-robin or least recently granted method) can approach 50%, and thus any alleviation of this waste represents a significant improvement. The various implementations of the present technology provide various approaches to raising the probability of a successful selection of an accessor for the next cycle above chance.

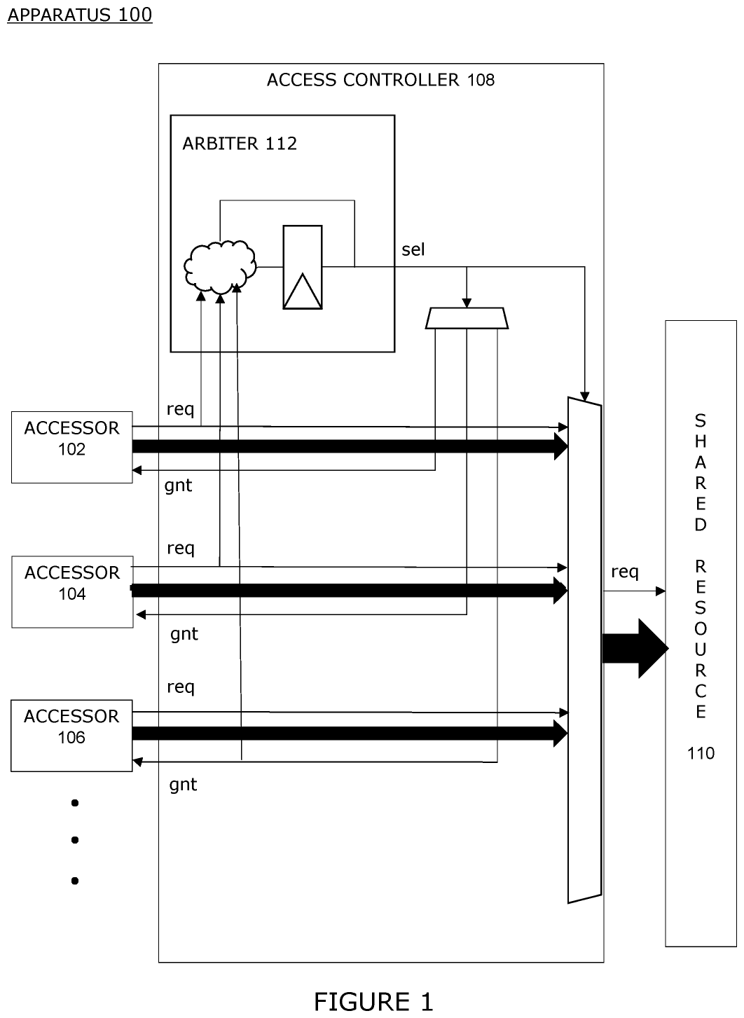

Turning to FIG. 1, there is shown a simplified example of an apparatus 100 according to an implementation of the present technology and comprising any combination of hardware, firmware, software and hybrid components. Apparatus 100 comprises a set of accessors 102, 104, 106 . . . . Accessors 102, 104, 106 . . . may be, for example, client computer programs, such as input/output drivers, client applications, computational units of neural networks and the like. As will be clear to one of skill in the art, there may be a further plurality of accessors, not shown here for convenience. The accessors 102, 104, 106 . . . are operable to issue requests (req) for access to shared resource 110, to receive grants of access (gnt) and to perform transactions requiring access (shown as the large dark arrows originating at accessors 102, 104, 106 . . . ). Shared resource 110 is typically operable to process a single transaction in any given processor cycle and thus the accessors' requests, the corresponding grants and all further communications to and from the shared resource must be handled using multiplexing and demultiplexing logic arrangements under the control of access controller 108. In access controller 108 according to the present implementation, an arbiter 112 receives the requests for grant (req) and selects (sel) the accessor 102, 104, 106 . . . that is to be issued with a grant (gnt) so that its request (req) for access to shared resource 110 can proceed. In the present implementation, arbiter 112 is a registered arbiter, that is, one in which the granting of resource access to an accessor is determined for a next processor cycle, rather than for the current processor cycle.

In the art, as is known, a registered arbiter (here shown as arbiter 112) operates so that the handshake between an accessor 102, 104, 106 . . . and the shared resource takes place on the completion of req and gnt for the next processor cycle. This approach is known to work well over time when multiple accessors 102, 104, 106 . . . share a single resource. Typically, however, even when the shared resource approaches full utilization, each accessor 102, 104, 106 . . . can be impacted by an initial stall before its first grant of access. This effect may be accentuated when a resource is arranged in a striped manner, wherein the access pattern may be affected by the striping. At its worst, when there are no steady runs of access requests matching grants, up to 50% of the bandwidth may be lost to stalls.

To alleviate this level of stalling, the embodiments of the present invention provide means for providing a predictive selection of an accessor 102, 104, 106 . . . for the next processor cycle, the predictive selection being based on the prior behaviour of one or more of the accessors 102, 104, 106 . . . , that aims to choose the accessor 102, 104, 106 . . . that is most likely to use the granted access and thereby save wasted processor cycles that could be better used. The embodiments may be implemented as a low-footprint addition to an access controller 108 that is otherwise unmodified, in particular as to its interfaces with accessors 102, 104, 106 . . . and resources, such as shared resource 110. In one implementation, for example, the effect of the present invention can be achieved using a two-bits per accessor prediction scheme. In other implementations, a register or a set of registers may be used to carry all the information needed for the arbiter 112 to perform its predictive function. All the disclosed implementations and variations thereof are operable to achieve the prediction task while maintaining economy of resource use, such as communications bandwidth and/or processor time.

An arbiter 112 according to the present technology may be implemented to incorporate any of a set of predictor functions, either singly or in combination.

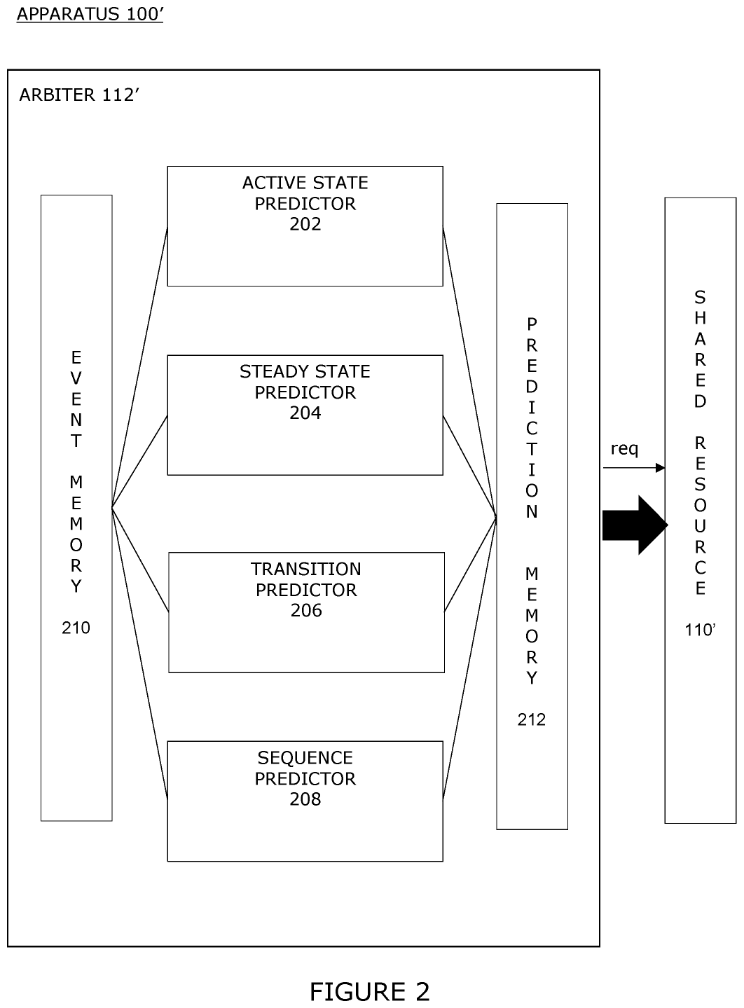

Turning now to FIG. 2, there is shown a simplified representation of apparatus 100′ according to an implementation of the present technology. Apparatus 100′ comprises arbiter 112′ operable to select an accessor (102, 104, 106 . . . not shown in FIG. 2) and to grant the chosen accessor access to shared resource 110′. Arbiter 112′ comprises an event memory 210 that is accessible to, and used by any one or a combination of predictors 202, 204, 206, 208. The predictors 202, 204, 206, 208 operate to apply predictive logic to inputs from event memory 210 in order to set the value or values of prediction memory 212, which in turn are used to determine the selection of an accessor to be granted access for the next processor cycle.

The logic of the arbiter 112′ is thus:
if no req received→keep currently granted accessor for next cycle
else if >=1 req received from non-granted accessor→grant new accessor according to RR or LRG
else if req received from granted accessor→act according to predictor function (see below)

A first predictor function that may be incorporated in the arbiter 112′ is an active state predictor 202. Active state predictor analyses the request and grant states for an accessor 102, 104, 106 . . . as represented in event memory 210 to determine whether it is an active requester and user of granted accesses, or whether it has been granted access, but has not then used that access. In the first case, where an accessor 102, 104, 106 . . . is positively identified as active, the active predictor places the accessor 102, 104, 106 . . . in a state to be eligible for selection to access the shared resource 110′ on a future processor cycle by setting a value in prediction memory 212 accordingly. In the second case, the predictor places the accessor 102, 104, 106 . . . in a state to be ineligible for selection to access the shared resource 110′ on the future processor cycle by setting a value in prediction memory 212 accordingly. If neither is the case, the predictor leaves the accessor state as it was. The prediction memory 212 may advantageously be initialised to label all clients as not active. This avoids giving unnecessary grants to accessors that have made no requests.

The logic for event detection in active state predictor 202 is as follows:
in cycle j, !req; followed by in cycle j+1, req→event=positive
in cycle j, !grant; followed by >=1 cycle !req && grant→event=negative
otherwise→no event

A simple form of active state predictor 202 forms its prediction by recording the last seen event and labelling the accessor as active if the last seen event was positive (event=positive) and not active if the last event seen was negative event=negative. The effect of the predictor is that, if no accessors are active (last seen event was negative for each accessor), the currently selected accessor is granted access. If one accessor is active (last seen event was positive), that active accessor is granted access. If multiple accessors are active (last seen event was positive), access is granted to the next in RR or LRG order.

The effect of the active state predictor 202 is thus to favour selection of accessors 102, 104, 106 . . . that have a short history of using granted accesses to perform resource transactions, and to disfavour accessors 102, 104, 106 . . . that have a history of receiving grants of access that they do not exploit. Active state predictor 202 may operate alone or in combination with a further predictor, such as a steady state predictor, as will be described below.

A second predictor function that may be incorporated in the arbiter 112′ is a steady state predictor 204. Steady state predictor analyses the request and grant states for an accessor 102, 104, 106 . . . as represented in event memory 210 to determine whether it is steady requester—that is, it has requested and been granted access, followed by a further request. If so, where an accessor 102, 104, 106 . . . is positively identified as steady, the steady state predictor places the accessor 102, 104, 106 . . . in a state to be eligible for selection to access the shared resource 110′ on a future processor cycle by setting a value in prediction memory 212 accordingly. If not, the predictor places the accessor 102, 104, 106 . . . in a state to be ineligible for selection to access the shared resource 110′ on the future processor cycle by setting a value in prediction memory 212 accordingly. If neither is the case, the predictor leaves the accessor state as it was. The prediction memory 212 may advantageously be initialised to label all clients as steady. In this way, the arbiter starts out by acting as a conventional arbiter without prediction.

The logic for event detection in steady state predictor 204 is as follows:
in cycle j, req && grant; followed by in cycle j+1, req→event=positive
in cycle j, req && grant; followed by in cycle j+1 !req→event=negative
otherwise→no event

A simple form of steady state predictor 204 forms its prediction by recording the last seen event and labelling an accessor as steady if the last seen event was positive (event=positive), and not steady if the last seen event was negative (event=negative). The effect of this predictor is that, if a granted accessor is steady (the last seen event was positive), that accessor is granted access on the next cycle. If the accessor is not steady (the last seen event was negative), access is granted to the next in RR or LRG order.

The effect of the steady state predictor 202 is thus to favour selection of accessors 102, 104, 106 . . . that have at least a short history of repeatedly using granted accesses to perform resource transactions, and to disfavour accessors 102, 104, 106 . . . that do not have such a history. Steady state predictor 202 may operate alone or in combination with a further predictor, such as an active state predictor, as will be described now.

If the active state predictor 202 and steady state predictor 204 are used together, the effect is that, if no accessors are active or the currently granted accessor is not steady, the current accessor is granted access. If one or more accessors are active and the currently granted accessor is not steady, the next active accessor in RR or LRG order is granted access.

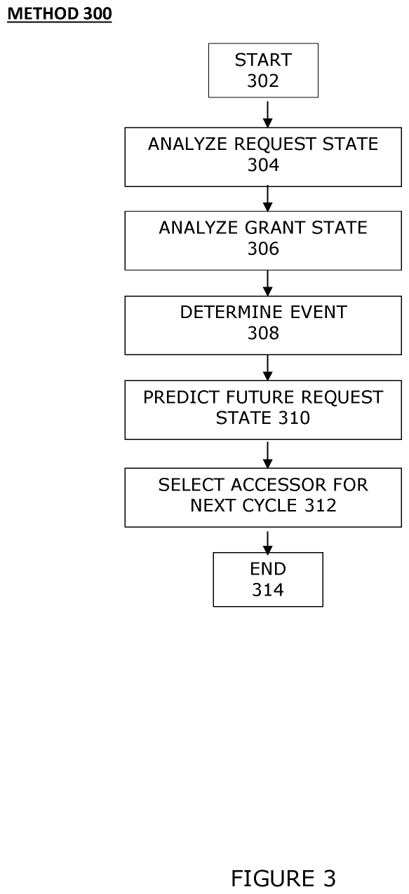

The method 300 of operation of an access controller according to an implementation of the present technology is shown in FIG. 3, beginning at START 302. At 304, the request state of at least one accessor is analyzed. At step 306, the grant state of at least one accessor is analyzed. From the analyses at 304, 306, an event is determined. From at least one event so determined, at 310, a request state of at least one accessor is predicted, and at 312, an accessor for the next cycle is selected using at least one prediction. The instance of method 300 completes at END 314. As will be clear to one of ordinary skill in the art, END 314 merely completes a single instance of method 300, and the method will typically be iterative, returning to START 302 for the next instance.

FIG. 2 illustrates predictors that make use both of an event memory, 210 and a prediction memory 212. The event memory 210 records information about past events, and the prediction memory 212 contains the current prediction, which is the current result of each predictor. For the simple predictors described hereinabove, there is no need to use two separate memories, as one storage bit can be used to record the last seen event and that will also be the current prediction. However, for a slightly more advanced predictor the event and prediction memories may be stored as two distinct entities.

One such more advanced predictor is two-bit predictor, which has the advantage that it is less sensitive to rare events. Two-bit predictors are known in the context of branch prediction, where they are appreciated for their capability to reduce misprediction rate at a low cost. A two-bit predictor as used in the context of the present invention has one bit in the event memory 210 to record the last seen event, and another bit in the prediction memory 212 to hold the current prediction.

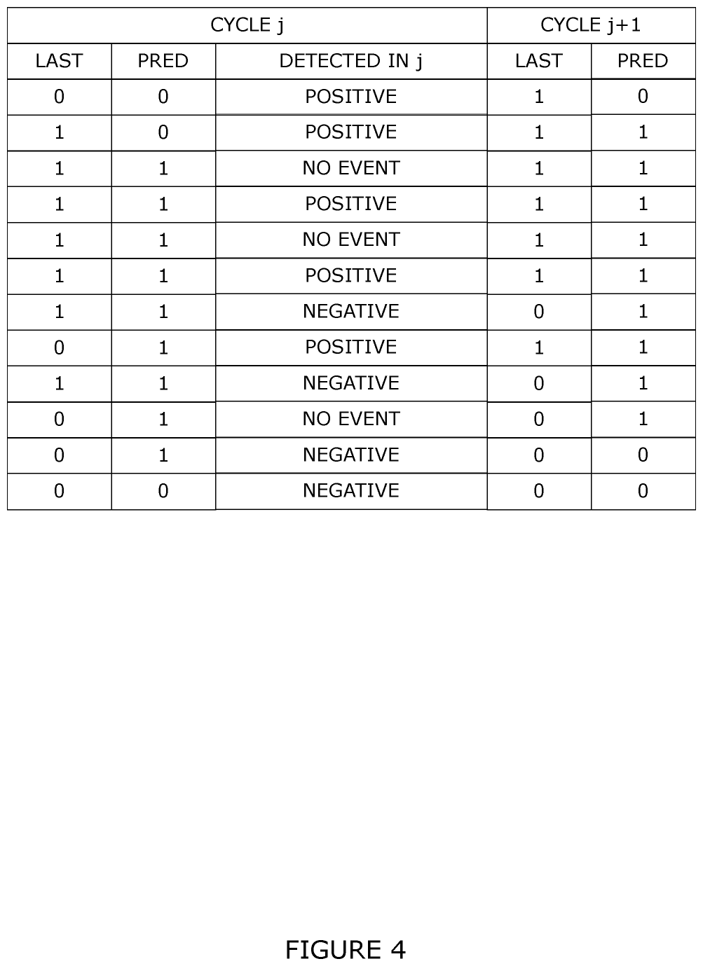

By separately remembering the last seen event, it can detect when a new event is of the same type as that seen most recently, and only then alter the prediction, achieving resilience to outlier events. Each of the active state predictor 202 and the steady predictor 204 may advantageously be of two-bit form. This in practice enhances their prediction accuracy, leading to greater utilization of the shared resource. The table shown in FIG. 4 gives an example of the operation of a two-bit-predictor according to an implementation of the present technology. While FIG. 2 illustrates the event memory 210 and a prediction memory 212 as completely separate memory entities, storage requirements are typically small enough to use flip flops rather than distinct RAM macrocells.

In further implementations of the present technology, an expanded form of event memory and/or prediction memory (that is, a memory capacity greater than two bits for each) may be used to provide for an expanded view of the history of granted accesses and/or for a priority scheme for granting access. The expanded memory may take the form of one or more registers comprising a plurality of bits. The registers may comprise shift registers for storage of data series in arrays. The expanded memory may further take the form of memory arrays comprising plural dimensions, such as a two-dimensional array. The data to be stored in the expanded memory may comprise data in conventional binary form or it may comprise “one-hot” data representing a selection of a single entity from a set of entities.

In a third implementation of the present technology, arbiter 112′ is provided with an expanded form of event memory 210 as described above, and is operable to analyze a history of grants of access. The expanded form of event memory 210 enables the arbiter 112′ to examine the history of more than one accessor to detect instances of transitions from a first accessor to a second accessor. As will be clear to one of skill in the art, this entails the creation and maintenance of a history indicating the identities of the accessors. The history may be maintained over a period of a plurality of processor cycles sufficient to contain indications of such transitions, each such indication having space for the identifiers of the relevant pair of accessors and the arbiter 112′ will thus require the above-described expanded form of event memory. If the arbiter 112′ detects that a current requester is a first accessor that previously, according to the history, transitioned to a second accessor, the prediction register is set to the identifier of the second accessor, so that the second accessor will be preferentially selected to receive a grant of access on future occasions where the first accessor has just received a grant of access. In this manner, the system takes advantage of the probability that an accessor that has been the starting point of a transition to a second accessor will be so again to increase the chances of predicting a correct accessor (that is, one that will be able to take advantage of its grant of access) to be selected for the next processor cycle.

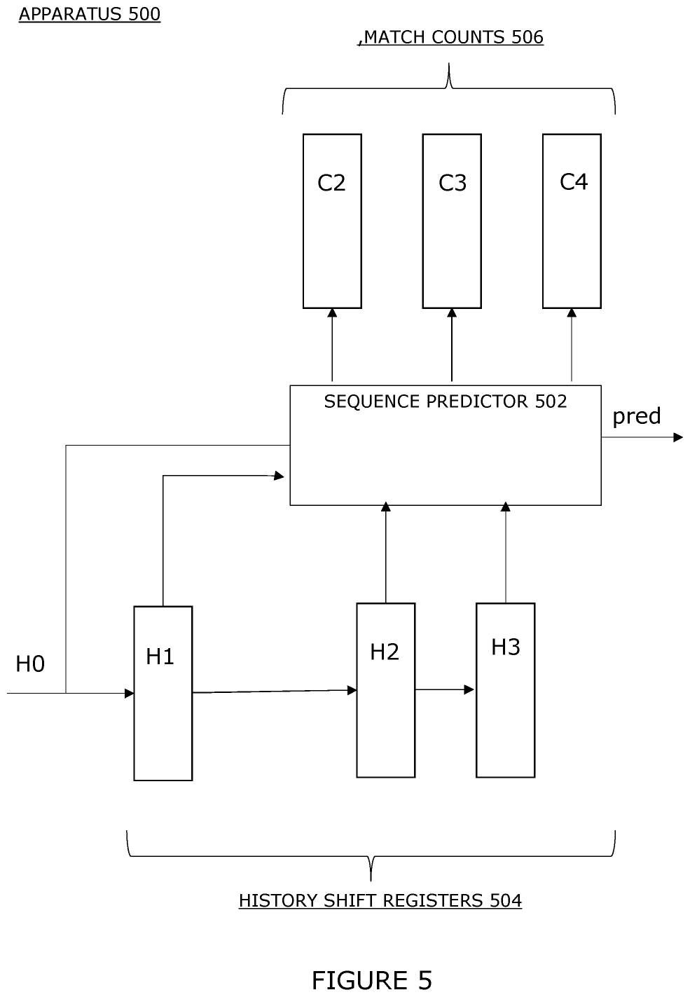

In a fourth implementation of the present technology, arbiter 112′ is provided with an expanded form of event memory 210 as described above, and is operable to analyze a history of grants of access. The expanded form of event memory 210 enables the arbiter 112′ to examine the history of more than one accessor to detect repeating sequences of grants. In the present implementation, parts of which are now shown as apparatus 500 in FIG. 5, the expanded form of the event memory 210 comprises history shift registers 504. History shift registers 504 are operatively coupled to sequence predictor 502, which is configured detect repeating sequences of granted accesses in history registers 504 using match counts 506. In this implementation, H0 represents the newest history register input and is tested for matches with known patterns. In the example shown in FIG. 5, there are three possible patterns to be tested against: ABABA, ABCABCA, and ABCDABCDA, where A-D represent identifiers of accessors. As will be clear to one of skill in the art, these represent a mere sample of the possible combinations, and the size of the registers and the lengths of the repeating patterns that are established will be determined according to the system storage and processing bandwidth that is available.

In the example implementation, if ABABA is detected, prediction H1 is output; if ABCABCA is detected, prediction H2 is output; if ABCDABCDA is detected, prediction H3 is output. If no pattern is detected, any of the predictions provided in the presently disclosed technology may be implemented, for example, by defaulting to use the currently granted accessor as the predicted accessor to be granted access for the next cycle.

In one variant of the implementation, a prediction output pred may take the form of an immediate selection of one of a set of accessors; in another variant it may take the form of a change in a priority order of potential accessors for the arbiter to select.

There is thus provided a technology for controlling access to shared resources wherein an access controller is configured to control access to a shared resource by a number of accessors each of which can issue requests for access to the shared resource as required. To raise the probability of selecting an accessor that is ready to make use of a grant of access above chance, the access controller comprises a predictor that is configured to analyze an activity of an accessor, for example by testing for an access request on a past and/or current processor cycle and/or testing for a used grant of access on a past and/or current processor cycle, to determine a type of at least one event and to predict a future request state of at least one of the accessors based on that determination. In one implementation, a future request state may be either HIGH or LOW, where HIGH indicates the predicted existence of a request on at least one future processor cycle. The access controller is then able to select one of the accessors to be granted access to the shared resource on a future processor cycle, using the prediction as input to the selection process.

The access controller may comprise a registered arbiter as described above, and the resource may comprise a memory, at least one request issued by an accessor comprising a request for read or write access to the memory.

In an implementation, the access controller's predictor comprises an active state predictor, which may be implemented to indicate a positive event when an accessor does not request access on a first processor cycle and does request access on a second processor cycle subsequent to the first processor cycle. In this implementation, the active state predictor may be configured to indicate a negative event when an accessor is not granted access on a first processor cycle, there is at least one second processor cycle, subsequent to the first processor cycle, wherein the accessor does not request but is granted access, and there is a third processor cycle, subsequent to the at least one second processor cycle, wherein the accessor is not granted access.

In an implementation, the predictor may or may also, comprise a steady state predictor. That is, the steady state predictor alone may operate, or it may operate in conjunction with an active state predictor as described above. The steady state predictor may be configured to indicate a positive event when an accessor does request access and is granted access on a first processor cycle and does request access on a second processor cycle subsequent to the first processor cycle. The steady state predictor may be further configured to indicate a negative event when an accessor does request access and is granted access on a first processor cycle and does not request access on a second processor cycle subsequent to the first processor cycle.

In access controllers according to the above-described implementations the first processor cycle and the second processor cycle may be consecutive. In these implementations, the access controller may be configured to send a grant signal to an accessor whose future request state is predicted to be high by the active state predictor when the predicted future request state of the currently granted accessor is predicted to be low by the steady state predictor. The predictor may be configured to predict a future request state as high when it has determined there have been two consecutive positive events.

In implementations as described above, the access controller comprises at least one two-bit memory for at least one respective accessor, the or each two-bit memory for storing an event bit indicating a determined event for that accessor and a prediction bit indicating the predicted future request state of that accessor. Predicting a future request state of at least one of the accessors then comprises determining an event, comparing the determined event to the event bit, and when the determined event is the same as the previously determined event represented by the event bit, setting the prediction bit according to the event bit.

In another implementation, the access controller comprises at least one two-register memory for at least one respective accessor, the or each two-register memory for storing an event register indicating a determined event for that accessor and a prediction register indicating a predicted future request state of that accessor. Indicating a predicted future request state of at least one of the accessors comprises determining an event, comparing the determined event to the event register, and when the determined event is the same as the previously determined event represented by the event register, setting the prediction register to the value of the event register. In this implementation, the predictor comprises a transition predictor operable to analyse a history of used grants of access to detect past instances of transitions from a first accessor to a second accessor, identify a determined event representing a used grant of access to the first accessor and set the prediction register to a value representing the second accessor.

In a yet further implementation, the access controller's predictor comprises a sequence predictor configured to analyze a history of used grants of access to detect past instances of repetitive patterns of accessors using granted access over a sequence of processor cycles and to increase a selection priority of an accessor in the plurality of accessors in response to a determination that it is predicted to be a next requester in a current instance of a repetitive pattern.

In any of the above implementations the access controller is operable to grant access to the accessor granted access on a most recent previous processor cycle when no other accessor is requesting access. If the access controller determines that an accessor is the only accessor requesting access and that accessor is predicted not to request on the next processor cycle, the access controller is operable to grant access to another accessor in a round-robin order. In an alternative, the access controller is operable to determine whether an accessor is the only accessor requesting access and, when that accessor is predicted not to request on the next processor cycle, to grant access to another accessor in a least-recently granted order.

The implementations described above may be incorporated into many types of resource accessing electronic systems, for example in any system in which one or more instances of shared memory need to be accessed by plural accessors.

In one example, the present technology may be deployed in an electronic crossbar structure for mediating between a plurality of accessors and a plurality of shared resources and comprising a plurality of access controllers. The wide usefulness of such a structure implementing the present technology will be clear to one of skill in the art. In one instance, the present technology may be deployed in a neural network accelerator comprising an electronic crossbar structure as described above, wherein the accessors comprise computational units of the neural network and the plurality of shared resources comprise memory buffer resources shared by the computational units.

As will be immediately clear to one of skill in the art, the usefulness of the present technology is not limited to the control of access to shared memory or data storage media, but is also applicable to other types of resource access, including, for example, communications channel transmission and receipt slots, control systems driver access time slices, adjunct processor resource accesses and the like.

As will be appreciated by one skilled in the art, the present techniques may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Furthermore, the present technique may take the form of a computer program product tangibly embodied in a non-transitory computer readable medium having computer readable program code embodied thereon. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored using fixed carrier media.

In one alternative, an embodiment of the present techniques may be realized in the form of a computer implemented method of deploying a service comprising steps of deploying computer program code operable to, when deployed into a computer infrastructure or network and executed thereon, cause the computer system or network to perform all the steps of the method.

In a further alternative, an embodiment of the present technique may be realized in the form of a data carrier having functional data thereon, the functional data comprising functional computer data structures to, when loaded into a computer system or network and operated upon thereby, enable the computer system to perform all the steps of the method.

It will be clear to one skilled in the art that many improvements and modifications can be made to the foregoing exemplary embodiments without departing from the scope of the present disclosure.

Embodiments disclosed herein include, for example:
1. An access controller configured to control access to a shared resource by plural accessors operable to issue requests for access to the shared resource, the access controller comprising a predictor configured to:
analyze an activity of an accessor to determine a type of at least one event;
predict a future request state of at least one of the accessors based on the determination; and
select one of the plurality of accessors to be granted access to the shared resource on a future processor cycle, the selecting being computed using at least the prediction.
2. An access controller according to claim 1, wherein analyzing the activity of an accessor comprises testing for an access request on a past and/or current processor cycle.
3. An access controller according to claim 1 or claim 2, wherein analyzing the activity of an accessor comprises testing for a used grant of access on a past and/or current processor cycle.
4. An access controller according to any preceding claim, wherein the predictor comprises an active state predictor configured to indicate a positive event when an accessor does not request access on a first processor cycle and does request access on a second processor cycle subsequent to the first processor cycle.
5. An access controller according to claim 4, wherein the active state predictor is configured to indicate a negative event when an accessor is not granted access on a first processor cycle, there is at least one second processor cycle, subsequent to the first processor cycle, wherein the accessor does not request but is granted access, and there is a third processor cycle, subsequent to the at least one second processor cycle, wherein the accessor is not granted access.
6. An access controller according to any preceding claim, wherein the predictor comprises a steady state predictor configured to indicate a positive event when an accessor does request access and is granted access on a first processor cycle and does request access on a second processor cycle subsequent to the first processor cycle, and to indicate a negative event when an accessor does request access and is granted access on a first processor cycle and does not request access on a second processor cycle subsequent to the first processor cycle.
7. An access controller according to any one of claims 4 to 6, wherein the first processor cycle and second processor cycle are consecutive.
8. An access controller according to any one of claims 5 to 7, configured to send a grant signal to an accessor whose future request state is predicted to be high by the active state predictor when the predicted future request state of the currently granted accessor is predicted to be low by the steady state predictor.
9. An access controller according to any preceding claim, wherein the predictor is configured to predict a future request state as high when it has determined there have been two consecutive positive events.
10. An access controller according to any preceding claim, wherein the access controller comprises at least one two-bit memory for at least one respective accessor, the or each two-bit memory for storing an event bit indicating a determined event for that accessor and a prediction bit indicating the predicted future request state of that accessor.
11. An access controller according to claim 10, wherein the predicting a future request state of at least one of the accessors comprises determining an event, comparing the determined event to the event bit, and when the determined event is the same as the previously determined event represented by the event bit, setting the prediction bit according to the event bit.
12. An access controller according to any of claims 1 to 4, wherein the access controller comprises at least one two-register memory for at least one respective accessor, the or each two-register memory for storing an event register indicating a determined event for that accessor and a prediction register indicating a predicted future request state of at least one accessor.
13. An access controller according to claim 12, wherein the indicating a predicted future request state of at least one of the accessors comprises determining an event, comparing the determined event to the event register, and when the determined event is the same as the previously determined event represented by the event register, setting the prediction register to the value of the event register.
14. An access controller according to claim 12 or claim 13, wherein the predictor comprises a transition predictor operable to:
analyse a history of used grants of access to detect past instances of transitions from a first accessor to a second accessor;
identify a determined event representing a used grant of access to the first accessor; and
set the prediction register to a value representing the second accessor.
15. An access controller according to any preceding claim, wherein the predictor comprises a sequence predictor configured to analyze a history of used grants of access to detect past instances of repetitive patterns of accessors using granted access over a sequence of processor cycles and to increase a selection priority of an accessor in the plurality of accessors in response to a determination that it is predicted to be a next requester in a current instance of a repetitive pattern.
16. An access controller according to any preceding claim, wherein the access controller is to grant access to the accessor granted access on a most recent previous processor cycle when no other accessor is requesting access.
17. An access controller according to any preceding claim, wherein the access controller is to determine whether an accessor is the only accessor requesting access and, when that accessor is predicted not to request on the next processor cycle, to grant access to another accessor in a round-robin order.
18. An access controller according to any of claims 1 to 16, wherein the access controller is to determine whether an accessor is the only accessor requesting access and, when that accessor is predicted not to request on the next processor cycle, to grant access to another accessor in a least-recently granted order.
19. An access controller according to any preceding claim, wherein the access controller comprises a registered arbiter.
20. An access controller according to any preceding claim, wherein the resource comprises a memory and wherein at least one request issued by an accessor comprises a request for read or write access to the memory.
21. An electronic crossbar structure for mediating between a plurality of accessors and a plurality of shared resources and comprising a plurality of access controllers according to any preceding claim.
22. A processor accelerator comprising an electronic crossbar structure according to claim 21, wherein the accessors comprise computational units of the processor and the plurality of shared resources comprise memory buffer resources shared by the computational units.
23. A method of operating an access controller to control access to a shared resource by plural accessors operable to issue requests for access to the shared resource, comprising:
analyzing an activity of an accessor to determine a type of at least one event;
predicting a future request state of at least one of the accessors based on the determination; and
selecting one of the plurality of accessors to be granted access to the shared resource on a future processor cycle, the selecting being computed using at least the prediction.
24. The method according to claim 23, wherein analyzing the activity of an accessor comprises testing for an access request on a past and/or current processor cycle and testing for a used grant of access on a past and/or current processor cycle.
25. A computer program comprising computer program code to, when loaded into a computer and executed thereon, cause the computer to perform the method of claim 23 or claim 24.

What is claimed is:

1. An access controller configured to control access to a shared resource by plural accessors operable to issue requests for access to the shared resource, the access controller comprising a predictor configured to:
analyze an activity of an accessor to determine a type of at least one event;
predict a future request state of at least one of the accessors based on the determination; and
select one of the plurality of accessors to be granted access to the shared resource on a future processor cycle, the selecting being computed using at least the prediction.

2. An access controller according to claim 1, wherein analyzing the activity of an accessor comprises testing for an access request on a past and/or current processor cycle.

3. An access controller according to claim 1, wherein analyzing the activity of an accessor comprises testing for a used grant of access on a past and/or current processor cycle.

4. An access controller according to claim 1, wherein the predictor comprises an active state predictor configured to indicate a positive event when an accessor does not request access on a first processor cycle and does request access on a second processor cycle subsequent to the first processor cycle.

5. An access controller according to claim 1, wherein the predictor comprises a steady state predictor configured to indicate a positive event when an accessor does request access and is granted access on a first processor cycle and does request access on a second processor cycle subsequent to the first processor cycle, and to indicate a negative event when an accessor does request access and is granted access on a first processor cycle and does not request access on a second processor cycle subsequent to the first processor cycle.

6. An access controller according to claim 1, wherein the first processor cycle and second processor cycle are consecutive.

7. An access controller according to claim 1, wherein the predictor is configured to predict a future request state as high when it has determined there have been two consecutive positive events.

8. An access controller according to claim 1, wherein the access controller comprises at least one two-bit memory for at least one respective accessor, the or each two-bit memory for storing an event bit indicating a determined event for that accessor and a prediction bit indicating the predicted future request state of that accessor.

9. An access controller according to claim 1, wherein the access controller comprises at least one two-register memory for at least one respective accessor, the or each two-register memory for storing an event register indicating a determined event for that accessor and a prediction register indicating a predicted future request state of at least one accessor.

10. An access controller according to claim 9, wherein the indicating a predicted future request state of at least one of the accessors comprises determining an event, comparing the determined event to the event register, and when the determined event is the same as the previously determined event represented by the event register, setting the prediction register to the value of the event register.

11. An access controller according to claim 9, wherein the predictor comprises a transition predictor operable to:
analyse a history of used grants of access to detect past instances of transitions from a first accessor to a second accessor;
identify a determined event representing a used grant of access to the first accessor; and
set the prediction register to a value representing the second accessor.

12. An access controller according to claim 1, wherein the predictor comprises a sequence predictor configured to analyze a history of used grants of access to detect past instances of repetitive patterns of accessors using granted access over a sequence of processor cycles and to increase a selection priority of an accessor in the plurality of accessors in response to a determination that it is predicted to be a next requester in a current instance of a repetitive pattern.

13. An access controller according to claim 1, wherein the access controller is to grant access to the accessor granted access on a most recent previous processor cycle when no other accessor is requesting access.

14. An access controller according to claim 1, wherein the access controller is to determine whether an accessor is the only accessor requesting access and, when that accessor is predicted not to request on the next processor cycle, to grant access to another accessor in a round-robin order or when that accessor is predicted not to request on the next processor cycle, to grant access to another accessor in a least-recently granted order.

15. An access controller according to claim 1, wherein the resource comprises a memory and wherein at least one request issued by an accessor comprises a request for read or write access to the memory.

16. An electronic crossbar structure for mediating between a plurality of accessors and a plurality of shared resources and comprising a plurality of access controllers according to claim 1.

17. A processor accelerator comprising an electronic crossbar structure according to claim 16, wherein the accessors comprise computational units of the processor and the plurality of shared resources comprise memory buffer resources shared by the computational units.

18. A method of operating an access controller to control access to a shared resource by plural accessors operable to issue requests for access to the shared resource, comprising:
analyzing an activity of an accessor to determine a type of at least one event;
predicting a future request state of at least one of the accessors based on the determination; and
selecting one of the plurality of accessors to be granted access to the shared resource on a future processor cycle, the selecting being computed using at least the prediction.

19. The method according to claim 18, wherein analyzing the activity of an accessor comprises testing for an access request on a past and/or current processor cycle and testing for a used grant of access on a past and/or current processor cycle.

20. A non-transitory computer readable medium having computer readable program code embodied thereon to, when loaded into a computer and executed thereon, cause the computer to:
analyze an activity of an accessor of a plurality of accessors, the plurality of accessors operable to issue requests for access to a shared resource, to determine a type of at least one event;
predict a future request state of at least one of the accessors based on the determined type; and
select one of the plurality of accessors to be granted access to the shared resource on a future processor cycle, the selection of the one of the plurality of accessors to be computed using at least the prediction of the future request state.
